(19) United States
(12) Patent Application Publication
(10) Pub. No.: US 2025/0200134 A1
(43) Pub. Date: Jun. 19, 2025

(54) METHOD FOR DETERMINING A CONTROL SEQUENCE FOR QUBIT INTERACTIONS AND RELATED QUANTUM CIRCUIT, QUANTUM DEVICE, AND METHOD FOR SOLVING A PROBLEM

(71) Applicant: IQM FINLAND Oy, Espoo (FI)

(72) Inventors: Pallasena Viswanathan SRILUCKSHMY, Espoo (FI); Martin LEIB, Espoo (FI); Vicente PINA CANELLES, Espoo (FI); Mario PONCE MARTINEZ, Espoo (FI); Hermanni HEIMONEN, Espoo (FI); Bruno TAKETANI, Espoo (FI); Inés DE VEGA, Espoo (FI)

(21) Appl. No.: 18/846,123

(22) PCT Filed: Mar. 14, 2022
(86) PCT No.: PCT/FI2022/050163

§ 371 Date: Sep. 11, 2024

(51) Int. Cl. G06F 17/16; G06N 10/20

(52) U.S. Cl. CPC G06F 17/16; G06N 10/20

(57) ABSTRACT

A computer-implemented method for determining a control sequence for performing a series of qubit interactions on a plurality of qubits on a quantum device to simulate a quantum many-body Hamiltonian. The method comprises determining a sequence of two-qubit interactions based on decomposing a multiqubit interaction term into a sequence of three interaction terms, a first interaction term involving a primary operator O, a second interaction term involving an auxiliary operator H, and a third interaction term involving the negative of the primary operator, wherein H and O are each a tensor product of at least two Pauli matrices, and the first, second and third interaction terms produced by the decomposition involve fewer qubits than the original multiqubit interaction term. The method further comprises iterative decomposition of interaction terms relating to primary operators and auxiliary operators until the multiqubit interaction term has been decomposed into a sequence of two-qubit interaction terms.

### TECHNICAL FIELD OF THE INVENTION

The invention relates to quantum computing in general. More specifically, the invention relates to a computer-implemented method for determining a control sequence for performing a series of qubit interactions on a plurality of qubits on a quantum device to simulate a quantum many-body Hamiltonian.

### BACKGROUND OF THE INVENTION

A quantum computer or quantum device is a machine that uses the properties of quantum physics to store data and perform computations. In comparison to a classical computer, which encodes information in the form of bits, e.g., 0s or 1s, a quantum computer uses quantum bits (qubits), which can be in a coherent superposition of two states simultaneously. A qubit may refer to a is basic unit of quantum information or to a quantum device (such as a two-level quantum-mechanical system) used to store a unit of quantum information. A quantum computer will thus generally comprise an array of qubits and hardware to manipulate these qubits.

There are three basic quantum computing methods: analog quantum model, universal quantum gate model (also known as digital quantum computing model or quantum circuit model) and quantum annealing. In the quantum gate model, manipulation of qubits or interaction between qubits is referred to as a gate, where a sequence of one or more gates arranged to be applied to qubits constitutes control sequence for the quantum device which may be referred to as a quantum circuit, which corresponds to instructions for manipulating the units of quantum information in order to perform a desired computation. Quantum gates can further be referred to as unitary operators represented by unitary matrices. Quantum gates acting on a plurality of qubits can further be referred to as an interaction between the plurality of qubits. Implementing a gate acting on a plurality of qubits on a quantum device corresponds to performing qubit interactions on the plurality of qubits. A unitary operator can thus also be referred to as an interaction term.

The many-body problem is a general name for a wide range of physical problems pertaining to the properties of systems comprising many interacting bodies, such as particles, where interaction between three or more bodies is referred to as a many-body interaction. As the complexity of classical simulations of quantum many-body systems typically grows exponentially with the dimension of the system, quantum computers can provide advantages for simulating many-body problems. Many-body interactions arise naturally in simulation of problems pertaining to fields such as quantum chemistry, finance, optimization, and high-energy physics. Thus, in order to simulate many-body problems on a quantum computer, simulation of many-body interactions utilizing qubits is required.

While quantum computers are well suited for simulation of quantum many-body systems, current quantum computers are limited by the number of qubits available as well as errors in the form of noise, faults and loss of quantum coherence. Accuracy of quantum computation results may decrease rapidly as the number of gate operations, circuit depth, and/or the number of is measurements increase.

Furthermore, although quantum error correction can be used in quantum computing to protect quantum information from errors due to decoherence and other quantum noise, quantum error correction requires additional qubits, the number of which are limited by the total available number of qubits. A problem associated with some of the known methods for simulating many-body interactions is the use of ancilla qubits, which reduce the number of remaining available qubits.

Some prior art methods also utilize a plurality of CNOT gates for solving many-body problems. One problem with such an approach in digital quantum computing is that CNOT gates are not always native for all of the qubit pairs in currently available quantum systems. Gates that are not native to the system need to be decomposed into a sequence of native gates, thus resulting in a higher number of gates used.

### SUMMARY OF THE INVENTION

An object of the invention is to alleviate at least some of the problems in the prior art. An object of the invention is to provide an alternative and/or improved methods or devices related to determining quantum gates to be applied to a plurality of qubits to simulate quantum many-body Hamiltonians or interactions. Some embodiments of the invention may be considered as providing a quantum compiler for providing quantum circuits. In accordance with one aspect of the present invention a computer-implemented method is provided for determining a control sequence for performing a series of qubit interactions on a plurality of qubits on a quantum device to simulate a quantum many-body Hamiltonian H_{d} involving M qubits, wherein the many-body Hamiltonian H_{d} is expressable as a tensor product of M Pauli matrices, the method comprising determining a sequence of two-qubit interactions based on decomposing a multiqubit interaction term into a sequence of three interaction terms, a first interaction term described by a unitary e^{iuO} of a primary operator O where u is a coupling strength coefficient of O between the qubits on which the primary operator O acts, a second interaction described by a unitary e^{iγH} of an auxiliary operator H, and a third interaction described by a unitary e^{-iuO} of the negative of the primary operator −O, wherein H and O are each a tensor product of at least two Pauli matrices, is wherein the first, second and third interaction terms produced by the decomposition involve fewer qubits than the original multiqubit interaction term, the method comprising iterative decomposition of interaction terms relating to primary operators and auxiliary operators until the multiqubit interaction term has been decomposed into a sequence of two-qubit interaction terms each relating to an operator comprising a tensor product of two Pauli matrices, wherein the multiqubit interaction term of the first decomposition step is described by a unitary e^{iγHd} of the many-body Hamiltonian H_{d}, where γ is a coupling strength coefficient of H_{d}, and the multiqubit interaction term in any subsequent decomposition step(s) relates to a primary operator O or an auxiliary operator H,

wherein said decomposing is based at least on a known or determined many-body Hamiltonian H_{d} which identifies the qubits to be involved and types of corresponding Pauli matrices.

In other words, a computer-implemented method may be provided for determining a control sequence for performing a series of one or more interactions on a plurality of qubits on a quantum device to simulate a quantum many-body Hamiltonian H_{d}, involving M qubits expressable as a tensor product of M Pauli matrices, the method comprising

determining a sequence of two-qubit interactions based on decomposing a multiqubit interaction term described by a unitary e^{iγHd} of the many-body Hamiltonian H_{d}, where γ is a coupling strength coefficient of H_{d} into a sequence of three interaction terms, a first interaction term described by a unitary e^{iuO} of a primary operator O where u is a coupling strength coefficient of O between the qubits on which the primary operator O acts, a second interaction term described by a unitary e^{iγH} of an auxiliary operator H, and a third interaction term described by a unitary e^{-iuO} of the negative of the primary operator −O, wherein H and O are each a tensor product of at least two Pauli matrices, involving M_{H} and M_{O} qubits, respectively,

if M_{O}>2, repeating the decomposing on the first interaction term into a sequence of three subsequent interaction terms, each involving less than M_{O} qubits, and repeating the decomposing on the third interaction term or obtaining a repeatedly decomposed third interaction term by changing the signs of the outcome of repeating the decomposing on the first interaction term,

if if M_{H}>2, repeating the decomposing on the second interaction term into a sequence of three subsequent interaction terms, each involving less than if M_{H} qubits,

iterating the decomposing of the resulting terms until the multiqubit interaction term has been decomposed into a sequence of two-qubit interaction terms each described by an operator comprising a tensor product of two Pauli matrices,

wherein said decomposing is based at least on a known or determined many-body Hamiltonian H_{d}, wherein the many-body Hamiltonian H_{d} identifies the qubits to be involved and types of corresponding Pauli matrices.

In the present text, decomposing of operators may refer to decomposing of corresponding interaction terms.

With the present invention, a solution for providing many-body gates by using native two-qubit gates (TQGs) (or possibly nearly native TQGs meaning TQGs and single-qubit gates (SQGs)) is provided. This may be advantageous as compared to solutions where CNOT gates are utilized.

In embodiments of the method, a final control sequence may comprise both SQGs and TQGs.

The number of gates, specifically preferably TQGs, required for simulating an M-body interaction may be reduced by at least one when compared to prior art approaches. Additionally, or alternatively, a circuit depth of the quantum circuit that is provided through the control sequence may be reduced as compared to prior art methods where the same M-body problem is solved. For instance, methods utilizing CNOT gates may result in a requirement of 2(M−1) TQGs and 2(M−1) circuit depth. With the present invention, however, a solution may be provided utilizing 2(M−1)−1 TQGs and resulting in a circuit depth of M−1 (for even M) or M (for odd M). In some embodiments, the circuit depth or number of TQGs may be reduced less than considered above, but also the avoidance of using CNOT gates may still provide benefits over the prior art.

A depth of a quantum circuit may refer to the number of time steps required for its completion. Therefore, reduction of circuit depth may result, in addition to reduced computation time, reduced errors, as quantum computations may involve increased error as the time required for computation is increased.

The present invention may also provide a solution where no ancilla qubits are required, thus the number of qubits needed may be reduced or optimized.

A quantum compiler or method according to the present invention may provide an automated and quicker way to determine an optimal circuit for a specific available quantum device.

A method according to the present invention may be advantageous in use cases where a quantum device does not provide connectivity/couplability between selected qubits which may be involved in a desired interaction term.

As an example, within the parity encoding scheme, any optimization problem is reduced to a Hamiltonian with single-body and four-body plaquette terms mapped to a square lattice. The implementation of the related Hamiltonian using CNOT gates can be done with a depth six circuit (only focusing on TQGs) and can be performed in four layers. With the present invention, however, the circuit depth may be reduced to four and may be carried out in two layers.

According to an embodiment of the invention, a computer-implemented method can be provided for determining a control sequence for performing a series of qubit interactions on a plurality of qubits on a quantum device for simulating a Hamiltonian of an optimization problem, where the Hamiltonian comprises a plurality of four-body plaquette terms mapped to a square lattice.

The method may comprise first decomposing the four-body plaquette terms according to the method of the invention described earlier and then optimizing the circuit by utilizing Pauli matrix commutation and identity relations in order to reduce the circuit depth and/or number of TQGs of the quantum circuit simulating the Hamiltonian of the optimization problem.

The method may at least partially be carried out by a first computing device, usually a classical computer, such that the method may additionally comprise providing the two-qubit interactions obtained through the method as the control sequence as a computer-readable output deliverable for implementing on a second computing device being a quantum device. The quantum device and the computing device that the method of the present invention is carried out on may be entirely separate devices or they may be coupled devices, wherein the control sequence may be directly deliverable to the quantum device or directly implementable thereon. The control sequence may is comprise or correspond to a sequence of quantum gates.

Preferably, the square of the primary operator O is equal to an identity matrix.

In one embodiment, the decomposing may additionally be based on a known or determined qubit coupling path, said qubit coupling path being indicative of qubit connecting links indicating at least the qubits of the many-body Hamiltonian H_{d} that are to be coupled when executing the determined control sequence on the quantum device.

A qubit coupling path may be obtained as an input or the qubit coupling path may be determined, wherein the determined qubit coupling path may lead to a selected circuit depth when the control sequence is executed on a quantum device. The selected circuit depth may be an optimal or minimum circuit depth that is available based on the many-body Hamiltonian and the identified qubits and in view of the qubit connectivity of the quantum device.

The method may comprise obtaining information on qubit connectivity of the quantum device. An obtained or determined qubit coupling path may be based on the qubit connectivity, such that the qubit connecting links are available in the qubit connectivity.

In some embodiments, it may be known or determined that multiple qubit coupling paths may be available, and a qubit coupling path may be selected such that the selected qubit coupling path contains the lowest number of qubit connecting links from a set of available qubit coupling paths. This qubit coupling path may be considered as an optimal or minimum qubit coupling path. If multiple shortest qubit coupling paths are available, one can e.g. be selected based on user input, a predefined selection preference of the method, or randomly.

If a qubit coupling path involves more qubits than the known or determined many-body Hamiltonian H_{d}, the method may comprise
determining a replacement Hd for replacing the many-body Hamiltonian H_{d} in the decomposing with the replacement Hd comprising M′>M qubits in the qubit coupling path,
the decomposing being carried out based on the replacement Hd, and
determining a sequence of two qubit interactions for implementing the original many-body Hamiltonian H_{d} by supplementing the is decomposed sequence of two-qubit interactions with additional at least two qubit interactions, comprising the steps of:
   selecting an additional at least two qubit interaction term described by a unitary e^{iA} of operator A, such that Hd and A anticommute, the square of A is equal to an identity matrix and the commutator of A and H′_{d} results in a new multiqubit interaction comprising a tensor product of a number N of Pauli matrices, where N<M′, wherein the selection of A is further based on the property that a square of a Pauli matrix is equal to an identity matrix,
   supplementing the decomposed sequence of two-qubit interactions with the selected two qubit interaction term on one side of the sequence and with the negative of the selected two qubit interaction term on the other side,
   replacing H′_{d} with the commutator of H′_{d} and A obtained in the above steps and repeating the above steps until N=M.

In cases where a qubit coupling path involves more qubits than the known or determined many-body Hamiltonian H_{d}, it could be that the many-body Hamiltonian term H_{d} involves qubits for which connectivity is not available (disconnected qubits) on a selected quantum device. A qubit coupling path may be determined, based on known connectivity of the device, that provides qubit connecting links between the disconnected qubits through connected or connectable qubits. The present invention may provide a method for determining a quantum circuit indicating qubit interactions that may be performed involving qubits that have connectivity on the selected quantum device to arrive at a solution that corresponds to the desired many-body Hamiltonian term H_{d}.

A qubit coupling path involving more qubits than the known or determined many-body Hamiltonian H_{d} may be obtained or determined also by the method first comprising obtaining a many-body Hamiltonian H_{d} and then determining, based on a qubit connectivity of the quantum device, that a qubit coupling path involving only qubits identified by the many-body Hamiltonian H_{d} is not possible. An alternative qubit coupling path involving additional qubits of the quantum device may then be determined, with such alternative qubit coupling path preferably involving a minimum number of qubits. The minimum number of qubits may be based on a shortest path available for is obtaining the alternative qubit coupling path. Such approach could be advantageous as it enables implementation of interactions between disconnected qubits without using SWAP gates, thus reducing computation time and thus also computation errors since a SWAP gate implementation is approximately three times slower than an implementation of one native TQG.

Alternatively, if it is determined that a qubit coupling path involving only qubits identified by the many-body Hamiltonian H_{d} is not possible, SWAP gates could be applied in order to connect the required qubits, in which case the control sequence for implementing many-body Hamiltonian H_{d} could comprise SWAP gates in addition to the control sequence determined by decomposing many-body Hamiltonian H_{d} according to the method of the invention.

In embodiments of the invention, the method may comprise
selecting at least one of the identified qubits as a central qubit,
selecting a first auxiliary operator H as a tensor product of M_{H} Pauli matrices, where each Pauli matrix in the tensor product acts on a different qubit, said qubits selected from those specified by the many-body Hamiltonian H_{d} and the selection including the at least one central qubit, and where M_{H} is less than the number of Pauli matrices of the multiqubit interaction being decomposed,
selecting a first primary operator O as a tensor product of M_{O} Pauli matrices, where M_{O} is less than the number of Pauli matrices of the multiqubit interaction being decomposed and where each Pauli matrix in the tensor product acts on a different qubit, said qubits and Pauli matrices of the first primary operator O selected such that at least one qubit is one of the least one central qubits and H_{d} is proportional to the commutator of the primary operator O and the auxiliary operator H,
selecting the coupling strength coefficient of O as μ=π/4+α*π where a is an integer, for isolating a single M-body term,
wherein the primary operator O and auxiliary operator H are selected to anticommute,
wherein the iterative decomposing comprises repeatedly selecting subsequent primary and auxiliary operators until the primary operator is and auxiliary operators are tensor products of two Pauli matrices and thus correspond to two-qubit interactions.

According to an embodiment of the invention, selecting at least one of the identified qubits as a central qubit may be based on qubit connectivity of the quantum device and/or a known or determined qubit coupling path.

With the selection of at least one central qubit (one if M is odd or two central qubits if M is even) and the decomposition taking into account the central qubit(s), a selected circuit depth may be provided. The selected circuit depth may be one that is optimized or minimal for the specific use case.

Selecting of a coupling strength as μ=π/4+α*π may result in being able to isolate an M-body term. For other coupling strengths, terms up to M-body are generated.

In some embodiments, a coupling strength coefficient of an auxiliary operator may be selected as π/4+α*π.

A method may also comprise obtaining information on qubit connectivity of the quantum device. If connectivity is indicative of a linear connectivity of qubits, wherein one qubit is couplable with at most two other qubits, the decomposing of a previously determined interaction term related to primary operator O may comprise reselecting the central qubit(s) before selecting subsequent primary and auxiliary operators, wherein the central qubit is now selected from qubits of the operator O related to the interaction term that is being decomposed.

The method may additionally comprise obtaining information indicative of native interactions or gates of the quantum device. The method may also comprise applying single-qubit gates in connection with two-qubit interactions in the control sequence that do not correspond to native interactions of the quantum device to obtain two-qubit interactions that correspond to native interactions of the quantum device.

One or more properties of the quantum device may in different embodiment of the invention be known or obtained, the properties comprising native gates of the device or connectivity of the device, for instance, and the one or more properties may be taken into account in the method.

A computer program product, comprising program code means adapted to execute the method items of embodiments of the present invention when run is on a computer, is also provided according to an aspect of the invention.

Yet, according to one aspect, a quantum circuit is provided, comprising a sequence of qubit interactions determined according to embodiments of the method of determining a control sequence, executable on a quantum device comprising at least M qubits for simulating a quantum many-body Hamiltonian.

A quantum device may also be provided, comprising at least M qubits, wherein the quantum device is configured to implement the sequence of qubit interactions determined according to the method of embodiments of the invention for providing a control sequence.

A method for determining at least one characteristic of a system according to independent claim 15 is also provided.

The novel features which are considered as characteristic of the invention are set forth in particular in the appended claims. The invention itself, however, both as to its construction and its method of operation, together with additional objects and advantages thereof, will be best understood from the following description of specific example embodiments when read in connection with the accompanying drawings.

### BRIEF DESCRIPTION OF THE DRAWINGS

Next the invention will be described in greater detail with reference to exemplary embodiments in accordance with the accompanying drawings, in which:

FIG. 1 illustrates a flow chart of a method and related schematic decomposition according to one embodiment of the invention.

FIG. 2 shows a flow chart of a method according to one embodiment of the invention.

FIG. 3 shows a flow chart of a method according to one embodiment of the invention.

FIG. 4 depicts exemplary connectivity of qubits.

FIG. 5 gives an example of a decomposition in terms of quantum circuits.

FIG. 6 illustrates one example of a control sequence as a quantum circuit.

FIG. 7 gives an example of a decomposition in terms of quantum circuits.

FIG. 8 illustrates one example of a control sequence as a quantum circuit.

FIG. 9 portrays a linear connectivity of qubits and shows exemplary qubit coupling paths.

FIG. 10 shows an example of a control sequence as a quantum circuit.

### DETAILED DESCRIPTION

Relating to the many-body problem, one of the considered challenges in quantum computing has been in optimally implementing a Hamiltonian H_{d}, which contains a string of Pauli terms acting on a number of different qubits, where the Hamiltonian describes the behavior of a many-body system and a quantum computation aims at implementing the dynamics generated by the Hamiltonian. The unitary that is to be implemented is of the form unitary U=e^{iγHd} (γ being the coupling strength constant of the Hamiltonian H_{d}). The present invention proposes a method to obtain and implement a single isolated Pauli string term. A string of Pauli terms could be, for example, σ_{z}⁰σ_{y}¹σ_{y}²σ_{y}³σ_{y}⁴σ_{z}⁵, where σ_{z}⁰ is a Z-type Pauli matrix acting on qubit 0, σ_{y}¹ is a Y-type Pauli matrix acting on qubit 1 and so on. Pauli matrices can be of X, Y, or Z types.

A non-commutative unitary transformation may be performed, where H_{d}=e^{iO}He^{-iO}, where O is a primary operator and H is an auxiliary operator, such that the primary operator and the auxiliary operator do not commute and contain a string of Pauli interactions. The primary operator O and auxiliary operator H may anticommute.

The task at hand is to appropriately find a scheme to obtain the terms of H and O and decompose them into TQGs, such that preferably the number of TQGs and/or the depth of the circuit is optimal. The identities given below for matrices P and R may be utilized, where equation (1) is Baker-Campbell-Hausdorff expansion and where the second identity (equation (2)) is derived is due to the fact that P is invertible which leads to the third identity (equation (3)) iff P⁻¹=−P:

$${e}^{P} R {e}^{- P} = R + [ P , R ] + \frac{1}{2 !} [ P , [ P , R ] ] + \frac{1}{3 !} [ P , [ P , [ P , R ] ] ] + … \qquad ( 1 )$$

$${e}^{P R {P}^{- 1}} = P {e}^{R} {P}^{- 1} \qquad ( 2 )$$

$${e}^{P} {e}^{R} {e}^{- P} = {e}^{R + [ P , R ] + \frac{1}{2 !} [ P , [ P , R ] ] + …} . \qquad ( 3 )$$

Giving e^{iγHd} in terms of coupling strength constant u for the primary operator O:

$${e}^{i γ {H}_{d}} = {e}^{i u O} {e}^{i γ H} {e}^{- i u O} = {e}^{i γ ( cos ( 2 u ) H + \frac{i}{2} sin ( 2 u ) [ O , H ] + O \{ O , H \} s i {n}^{2} u )} . \qquad ( 4 )$$

Combining the above equations with a selection of the coupling strength constant μ=π/4+α*π, equation (4) reduces to a much simpler and easier to handle as well as implement form of e^{iγ(1/2[O,H]+1/2O(O,H))}. If the primary operator O and auxiliary operator H further anticommute, then equation (4) further simplifies to

$${e}^{- \frac{1}{2} γ [ O , H ]} .$$

With the above,

$$U = {e}^{i γ {H}_{d}} = {e}^{i \frac{π}{4} O} {e}^{i γ H} {e}^{- i \frac{π}{4} O} = {e}^{i γ ( H + \frac{i π}{4} [ O , H ] + \frac{{i}^{2} {π}^{2}}{2 ! {4}^{2}} [ O , [ O , H ] ] … )} , \qquad ( 5 )$$

where the coupling strength of O has cleverly been set to

$$\frac{π}{4} .$$

Using [0, H]≠0 and {0, H}=0 with O, H Hermitian operators and that O² and H² shall equal identity:

$${e}^{i α O} = cos ( α ) T + i sin ( α ) O . \qquad ( 6 )$$

Combining the properties above:

$$U = {e}^{i γ {H}_{d}} = {e}^{\frac{i γ}{2} ( I + iO ) H ( I - iO )} \qquad ( 7 )$$

$$= {e}^{\frac{i γ}{2} ( O \{ O , H \} + i [ O , H ] )} . \qquad ( 8 )$$

This gives

$${H}_{d} = \frac{i}{2} [ O , H ] .$$

Using the above, a sequence of terms can be generated and setting the coupling strength of the primary operator O appropriately, an isolated many-body term can be generated. This term could then also be rotated individually to get the required combination of Pauli matrix type X, Y and Z operations of the many-body term. Such a protocol can be implemented on the quantum computer, without any ancilla qubits, using a digital algorithm where the is unitary transformations are represented by gates.

In some embodiments, after decomposition, a final control sequence of interactions can be expressed as H_{d}=e^{iO′}H′e^{-iO′}, where H′ is a central final auxiliary operator H, and O′ is a sum of all the final primary and auxiliary operators O and H except for the central final auxiliary operator and where H′ and O′ do not commute and any summand of the O′ commutes with any other summand of O′. Examples of such final control sequences being represented as digital quantum circuits will be depicted later herein in FIGS. 6, 8, and 10.

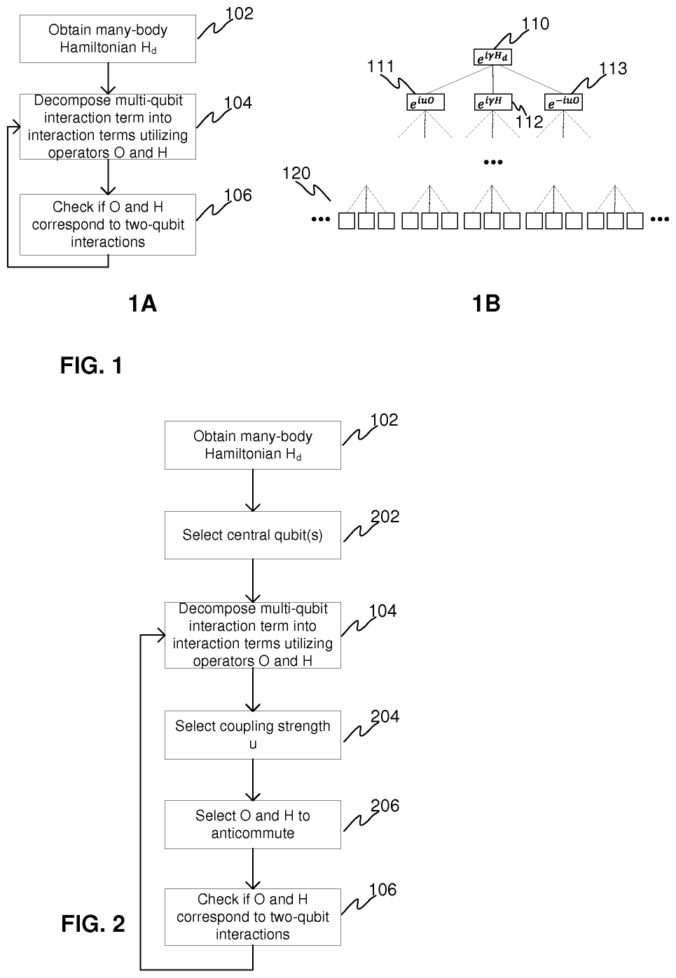

The present invention involves a computer-implemented method for determining a control sequence for performing a series of qubit interactions on a plurality of qubits on a quantum device to simulate a quantum many-body Hamiltonian, involving decomposing a multiqubit interaction term 110 into a sequence of three interaction terms 111, 112, 113 as illustrated schematically in FIG. 1B. A first interaction term 111 is described by a unitary e^{iuO} of a primary operator O where u is a coupling strength coefficient of O between the qubits on which the primary operator O acts. A second interaction term 112 is described by a unitary e^{iγH} of an auxiliary operator H, while a third interaction term 113 is described by a unitary e^{-iuO} of the negative of the primary operator −O, and H and O are each a tensor product of at least two Pauli matrices. The first 111, second 112 and third 113 interaction terms produced by the decomposition 104 involve fewer qubits than the original multiqubit interaction term 110.

A desired many-body Hamiltonian H_{d} involving M qubits may be known or determined. The many-body Hamiltonian H_{d} may be expressable as a tensor product of M Pauli matrices and identifies the qubits to be involved and types of corresponding Pauli matrices. Referring to FIG. 1 and regarding one embodiment of the present invention, the many-body Hamiltonian H_{d} may be obtained 102 e.g., as an input by the first computing device comprising at least one processor that is utilized to carry out the method for determining a control sequence. H_{d} may be known or determined based on a problem to be solved involving a system comprising M bodies, where a certain characteristic is of the system is to be determined.

The input(s) considered may be obtained by the first computing device, and they may, e.g., be provided by a user of the first computing device or by another computing program determining the input(s) based on additional information provided by the user, where the additional information could be, e.g., properties describing the quantum device on which a specific many-body interaction is to be implemented and/or desired properties of the many-body interaction. At least some of the methods considered herein may be carried out without all the possible information considered here as possible inputs being provided. It may be understood by the skilled person that a method according to the invention may be implementable such that any M, H_{d}, qubit connectivity, or qubit coupling path could be possible.

In one embodiment, an input obtained in the method may comprise at least a number M identifying a size of the many-body term, i.e. the number of bodies involved, a qubit number vector [i,j,k,l . . . ] identifying the desired qubit numbers to be involved in the many-body Hamiltonian, and the corresponding Pauli operator numbers given by a vector of the same size as the qubit number vector, such as [1,2,3,2 . . . ] where numbers 1, 2, 3 indicate the Pauli matrix types X, Y, Z respectively.

Some of the information utilized in the method may be determined from possible inputs obtained. For example, in one embodiment, an input obtained in the method may comprise at least a qubit number vector [i,j,k,l . . . ] identifying the desired qubit numbers to be involved in the many-body Hamiltonian, and the corresponding Pauli operator numbers given by a vector of the same size as the qubit number vector, such as [1,2,3,2 . . . ] where numbers 1, 2, 3 indicate the Pauli matrix types X, Y, Z respectively. The number M identifying the size of the many-body term can then be determined from the size of the qubit number vector or the Pauli operator types vector. Alternatively, an input obtained in the method may comprise at least a number M identifying a size of the many-body term, i.e., the number of bodies and a qubit connectivity of a quantum device. The qubit number vector could then be determined based on the number M and the qubit connectivity of the quantum device. The Pauli operator types could be assigned randomly or determined based on the qubit connectivity of the quantum device and a further input comprising a set of native gates available.

The term “qubit number” may refer to a number that is used to identify specific qubits comprised in a specific quantum device. Of course, other identifiers could also be used instead of numbers.

The method may comprise iterative decomposition of interaction terms involving primary operators and auxiliary operators until the multiqubit interaction term 110 has been decomposed into a sequence of two-qubit interaction terms 120 each described by an operator comprising a tensor product of two Pauli matrices.

The multiqubit interaction term 110 of the first decomposition step 104 may be described by a unitary e^{iγH}d of the many-body Hamiltonian H_{d}, where V is a coupling strength coefficient of H_{d}, and the multiqubit interaction term 110 in the subsequent decomposition step(s) may be related to a primary operator O or an auxiliary operator H if said operators are not two-qubit interaction terms (i.e., if they act on more than two qubits).

The operators comprising a tensor product of two Pauli matrices may be one of σₓⁱσₓ^{j}, σ_{y}ⁱσ_{y}^{j}, σ_{z}ⁱσ_{z}^{j}, σₓⁱσ_{y}^{j}, σₓⁱσ_{z}^{j}, σ_{y}ⁱσ_{z}^{j}, where i≠j are qubit numbers and X, Y, Z refer to Pauli matrix type. In a particular embodiment, the operators comprising a tensor product of two Pauli matrices can correspond to Ising Coupling gates, corresponding to the σₓⁱσₓ^{j}, σ_{y}ⁱσ_{y}^{j} σ_{z}ⁱσ_{z}^{j} operators. It is worth noting that Ising Coupling gates are natively implementable in some trapped-ion quantum computers.

At step 104 of FIG. 1A, the many-body Hamiltonian H_{d} is taken in a first decomposition step, where the corresponding multi-qubit interaction is decomposed utilizing at least a first primary operator O and a first auxiliary operator H.

In some embodiments, the method may comprise a checking step 106 to check if the previously obtained primary operator O and auxiliary operator H correspond to two-qubit interactions. If not, the method may comprise repeating at least the steps 104 and 106 with the one or more primary operator(s) O and/or auxiliary operator(s) H last obtained, which is/are not corresponding to two-qubit interactions, until primary operators O and auxiliary operators H comprise only two-qubit interaction terms 120.

Thus, a method may comprise decomposing a multiqubit interaction term 110 described by a unitary e^{iγH}d of the many-body Hamiltonian H_{d}, into a sequence of three interaction terms, a first interaction term 111 described by is a unitary e^{iuO} of a primary operator O where u is a coupling strength coefficient of O between the qubits on which the primary operator O acts, a second interaction term 112 described by a unitary e^{iγH} of an auxiliary operator H, and a third interaction term 113 described by a unitary e^{-iuO} of the negative of the primary operator −O, wherein H and O are each a tensor product of at least two Pauli matrices, involving M_{H} and M_{O} qubits, respectively.

In the method, if M_{O}>2, the decomposing may be repeated on the first interaction term 111, decomposing it into a sequence of three subsequent interaction terms, each involving less than M_{O} qubits. The method may then also comprise repeating the decomposing on the third interaction term 113 or obtaining a repeatedly decomposed third interaction term 113 by changing the signs of the outcome of repeating the decomposing on the first interaction term 111.

If M_{H}>2, the decomposing may be repeated on the second interaction term 112, decomposing it into a sequence of three subsequent interaction terms, each involving less than M_{H} qubits.

The decomposing of the resulting terms may be iterated until the multiqubit interaction e^{iγH} has been decomposed into a series of at least three two-qubit interaction terms 120.

FIG. 1B shows schematically how the method may be used to decompose the interaction terms 110, 111, 112, 113, finally arriving at two-qubit interactions 120. The rectangular boxes in FIG. 1B illustrate gates, unitary transformations or interaction terms. The lines in FIG. 1B indicate that each interaction term, which comprises interaction between more than two qubits, is decomposed into three further interaction terms, which can then be further decomposed into subsequent three interaction terms and so on until all interaction terms are decomposed into two qubit interaction terms. The top row in FIG. 1B thus shows the many-body interaction term 110 that is to be decomposed, whereas the bottom row in FIG. 1B shows the resulting control sequence comprising a plurality of two qubit interaction terms or TQGs 120.

In some embodiments and referring to FIG. 2, the method may comprise firstly selecting 202 at least one of the identified qubits in the many-body Hamiltonian H_{d} as a central qubit. One central qubit may be selected if M is is odd and two central qubits if M is even. In the case of odd M, a second qubit, adjacent to the central qubit, could be selected in addition to the central qubit.

A central qubit may be defined as at least one of the identified qubits in the many-body Hamiltonian H_{d}, where the longest chain determined from a set of shortest chains linking the central qubit to any other qubit of the many-body Hamiltonian H_{d} via the qubits of the many-body Hamiltonian H_{d}, the longest chain comprising the largest number of qubit connecting links, involves a smaller or equal number of qubits compared to the longest chain determined from a set of shortest chains linking any non-central qubit to any other qubit of the many-body Hamiltonian H_{d} via the qubits of the many-body Hamiltonian H_{d}.

A first auxiliary operator H may be selected as a tensor product of M_{H} Pauli matrices, where each Pauli matrix in the tensor product acts on a different qubit, said qubits selected from those specified by the many-body Hamiltonian H_{d} and the selection including the at least one central qubit, and where M_{H} is less than the number of Pauli matrices of the multiqubit interaction being decomposed.

A first primary operator O may be selected as a tensor product of M_{O} Pauli matrices, where M_{O} is less than the number of Pauli matrices of the multiqubit interaction being decomposed and where each Pauli matrix in the tensor product acts on a different qubit, the qubits and Pauli matrices of the first primary operator O selected such that at least one qubit is one of the least one central qubits and H_{d} is proportional to the commutator of the primary operator O and the auxiliary operator H.

Furthermore, the coupling strength coefficient of the primary operator O may be selected 204 as μ=π/4+α*π, and the primary operator O and auxiliary operator H may be selected 206 to anticommute. The steps 204 and/or 206 may also be carried out in differing order.

The iterative decomposing may then comprise repeatedly selecting subsequent primary and auxiliary operators until the final primary operator and final auxiliary operators are tensor products of two Pauli matrices and thus correspond to two-qubit interactions.

The decomposing may take into account a qubit connectivity or topology of the quantum device, which may be known or may be obtained.

In some embodiments, a qubit connectivity may be obtained as an input, e.g., is as a list of two element vectors indicating which qubits are connected. For example, [2,3], [3,4], [4,5] could indicate that qubits identified with numbers 2, 3, 4, 5 are connectable/couplable linearly.

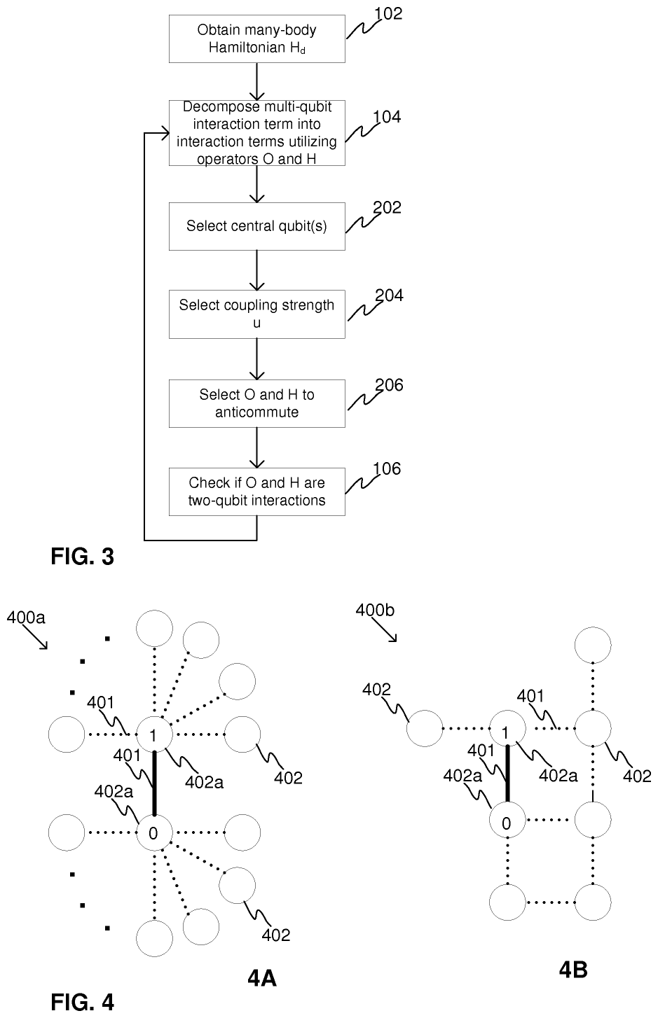

FIG. 2 shows a general embodiment of the method, which may be applicable, e.g., to a branched topology or qubit connectivity, which will be discussed further below. FIG. 3, however, exhibits a flow chart of the method as applied to a linear qubit connectivity, such as that which is seen in square lattice qubit topologies. In such linear topologies, all qubits may be connected to form a qubit coupling path such that any one qubit in the path is coupled with at most two other qubits.

Here, the selection 202 of central qubit(s) may occur each time the decomposition is carried out. Thus, if a known or obtained connectivity of a quantum device is indicative of a linear connectivity of qubits, the decomposing of a previously determined primary operator O may comprise reselecting the central qubit(s) before selecting subsequent primary and auxiliary operators, wherein the central qubit is now selected from qubits of the operator O that is being decomposed.

In some embodiments, a qubit connectivity of the quantum device may be indicative of a branched connectivity of qubits, comprising at least a first qubit and a second qubit and a plurality of additional qubits, where the first qubit is couplable to the second qubit and additional qubits are couplable only to one of the first or second qubits.

One embodiment of the invention may thus also relate to a quantum device comprising at least M qubits, wherein said device comprises a branched qubit connectivity and is configured to implement the sequence of qubit interactions determined according to the method herein.

FIG. 4 shows at 4A schematically a branched qubit connectivity 400a, where circles represent qubits 402 (not all qubits labelled), solid lines refer to a ZZ link, and dashed lines refer to an XX link. The links 401 (or qubit connectivities/couplings) may be any tensor product of two Pauli matrices selected from the X, Y and Z Pauli matrices. The selection of the specific implementation may depend on the available native gates or interactions of the quantum device. In this example, ZZ and XX are chosen. In one example, is the quantum device may be a superconducting quantum chip device. Any other type of quantum device may also be chosen, such that other native gates may be possible. It may also be possible that only one gate is native, while the other is obtained from such a native gate and native SQGs.

In one embodiment, the method may comprise information indicative of native interactions or gates of the quantum device. This information may be used in the method to convert non-native TQGs into native gates if necessary. The information characterizing the native gates of the quantum device (or second computing device) may be, e.g., obtained as an input or may be known.

In the example of FIG. 4, it may also be considered that the solid line links two central qubits 402a (numbered here as qubits 0 and 1, which could be referred to e.g., as q⁰ and q¹) of a possible considered M-body interaction. In a branched connectivity there may always be two central qubits independent of whether M is even or odd.

FIG. 4B shows an example of a linear connectivity of qubits 402. Also here, if M is even, then there may be two central qubits 402a (numbered as qubits 0 and 1). Yet, if M is odd then there may be only one central qubit.

One exemplary method of determining a control sequence is considered as follows. A many-body Hamiltonian H_{d} of σ_{z}⁰σ_{y}¹σ_{y}²σ_{y}³σ_{y}⁴σ_{z}⁵ considering six bodies may be obtained or known (with H_{d} here being merely exemplary). It may also be known or determined that the connectivity of the device is of a branched topology.

In a first step, central qubits identified here as qubits numbered 2 and 3 may then be selected. A second step may then comprise decomposing, comprising determining a first primary operator 0=σ_{z}⁰σ_{y}¹σₓ² and first auxiliary operator H=σ_{z}²σ_{y}³σ_{y}⁴σ_{z}⁵ to obtain

$${U}_{D} = {e}^{i γ {H}_{d}} = {e}^{i \frac{π}{4} O} {e}^{i γ H} {e}^{- i \frac{π}{4} O} and {H}_{D} = \frac{i}{2} [ O , H ] .$$

As seen, the obtained primary operator O and auxiliary operator H are not two-qubit interactions. The decomposing may then be carried out iteratively. In a third step of the method decomposing is repeated, and the first auxiliary operator H ma be used as the new multi-qubit interaction be decomposed, where

$${e}^{i γ H} = {e}^{i \frac{π}{4} {O}_{n}} {e}^{i γ {H}_{n}} {e}^{- i \frac{π}{4} {O}_{n}} and {H}_{D} = \frac{i}{2} [ {O}_{n} , {H}_{n} ] ,$$

with selected second primary operator Oₙ=σₓ³σ_{y}⁴σ_{z}⁵ and selected second auxiliary operator Hₙ=σ_{z}²σ_{z}³.

In a fourth step of the method, the first primary operator O and second primary operator On, which are three-body terms, may be further decomposed as

$${e}^{i γ O} = {e}^{i \frac{π}{4} {O}_{p}} {e}^{i γ {H}_{p}} {e}^{- i \frac{π}{4} {O}_{p}} , O = \frac{i}{2} [ {O}_{p} , {H}_{p} ] , {e}^{i γ {O}_{n}} = {e}^{i \frac{π}{4} {O}_{r}} {e}^{i γ {H}_{r}} {e}^{- i \frac{π}{4} {O}_{r}} , {O}_{n} = \frac{i}{2} [ {O}_{r} , {H}_{r} ] ,$$

with selected third primary operator Oₚ=σ_{z}⁰σ_{z}², third auxiliary operator Hₚ=σ_{y}¹σ_{y}², fourth primary operator Oᵣ=σ_{z}³σ_{z}⁵, and fourth auxiliary operator Hᵣ=σ_{y}³σ_{y}⁴.

The multi-qubit interaction H_{d} has then been decomposed utilizing primary operators O and auxiliary operators H that are two-qubit interactions.

The obtained term may be compared with the initial desired many-body Hamiltonian term H_{d}. In this example, it may be seen that these are equivalent and no further SQGs are required. However, if this were not the case, then one layer may be applied before and after the applied interactions, to obtain the correct Pauli operators. Moreover, further SQGs can be applied to convert any non-native TQGs into native ones. Since gates of XX and ZZ type are considered to be native also in this example, as is done elsewhere in this text, the third auxiliary operator Hₚ=σ_{y}¹σ_{y}² and the fourth auxiliary operator Hᵣ=σ_{y}³σ_{y}⁴ will have SQGs applied before and after these interactions in order to convert them into native gates.

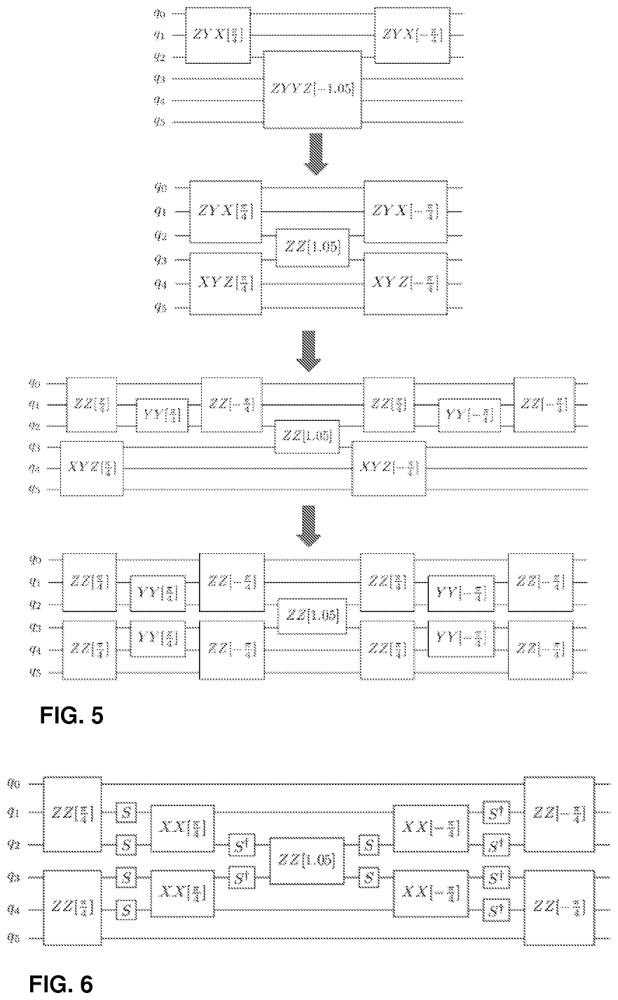

The above decomposition, i.e., the sequence of steps carried out algorithmically using operators and their unitaries, is depicted in terms of quantum circuits in FIG. 5. FIG. 6 showing a parallelized quantum circuit that may be determined for the above considered example, where the number of TQGs and/or circuit depth is optimized.

Each horizontal line in FIG. 5 starting from a marking qⁱ, which indicates the qubit number i, corresponds to the qubit qⁱ. Each rectangle in FIG. 5 refers to a gate, where a rectangle with

$$ZYX [ \frac{π}{4} ]$$

label and crossing qubit lines q⁰, q¹, q² illustrates a gate designed to implement a Hamiltonian σ_{z}⁰σ_{y}¹σₓ² with coupling strength of

$$\frac{π}{4} .$$

A gate labeled only with two letters indicates a TQG acting on two qubits, where in the case of the gate representing rectangle crossing over three or more qubit lines, the TQG acts on the topmost and bottom most qubit lines.

The first quantum circuit of FIG. 5 illustrates the control sequence represented is by a quantum circuit obtained after the second step of the above-described decomposition. The first gate corresponds to the interaction term

$${e}^{i \frac{π}{4} O} ,$$

the second gate to the interaction term e^{-1.05iH}, and the third gate to the interaction term

$${e}^{- i \frac{π}{4} O} .$$

The second quantum circuit of FIG. 5 shows the quantum circuit obtained after the third step of the above-described decomposition. The second quantum circuit is the same as the first circuit but the gate corresponding to e^{-1.05iH} is now split into three gates

$${e}^{i \frac{π}{4} {O}_{n}} ,$$

e^{1.05iH}, and

$${e}^{- i \frac{π}{4} {O}_{n}}$$

respectively. In the third quantum circuit of FIG. 5, the gates corresponding to

$${e}^{i \frac{π}{4} O} and {e}^{- i \frac{π}{4} O}$$

are decomposed further into gates corresponding to

$${e}^{i \frac{π}{4} {O}_{p} ,} {e}^{i \frac{π}{4} {H}_{p} ,} {e}^{- i \frac{π}{4} {O}_{p}} and {e}^{i \frac{π}{4} {O}_{p} ,} {e}^{- i \frac{π}{4} {H}_{p} ,} {e}^{- i \frac{π}{4} {O}_{p}}$$

respectively, In the fourth quantum circuit of FIG. 5, the gates corresponding to

$${e}^{i \frac{π}{4} {O}_{n}} and {e}^{- i \frac{π}{4} {O}_{n}}$$

are decomposed further into gates corresponding to

$${e}^{i \frac{π}{4} {O}_{r} ,} {e}^{i \frac{π}{4} {H}_{r} ,} {e}^{- i \frac{π}{4} {O}_{r}} and {e}^{i \frac{π}{4} {O}_{r} ,} {e}^{- i \frac{π}{4} {H}_{r} ,} {e}^{- i \frac{π}{4} {O}_{r}}$$

respectively.

As illustrated in FIG. 6, the final quantum circuit of FIG. 5 is further optimized to reduce the number of TQGs and/or circuit depth of the quantum circuit, and additional gates are applied in order to convert all the needed gates into gates native to the available quantum device. In the particular example of FIG. 6, the ZZ-type gates in the middle of the fourth quantum circuit of FIG. 5 (at the circuit depths 3-5) all commute and thus the gates with opposite signs but acting on the same qubits cancel out thus reducing the number of TQGs and circuit depth of the quantum circuit. Further, in the specific example of FIG. 6, ZZ-type and XX-type gates are considered to be native together with single qubit gates (SQGs) marked as S in the quantum circuit. In the case that YY-type gates are not native, FIG. 6 shows the conversion of YY-type gates into XX-type gates by application of SQGs.

A further exemplary method of determining a control sequence is given below where a linear connectivity of qubits is employed.

Also in this example, as in the above example, a many-body Hamiltonian H_{d} of σ_{z}⁰σ_{y}¹σ_{y}²σ_{y}³σ_{y}⁴σ_{z}⁵ considering six bodies may be obtained or known (with H_{d} here being merely exemplary). It may also be known or determined that the connectivity of the device is of a linear topology.

In a first step, central qubits identified here as qubits numbered 2 and 3 may then be selected.

The second and the third steps may be the same as in the case of the is branched connectivity of qubits.

In a fourth step of the method, the first primary operator O and second primary operator Oₙ, which are three-body terms, may be further decomposed as

$${e}^{i γ O} = {e}^{i \frac{π}{4} {O}_{p}} {e}^{i γ {H}_{p}} {e}^{- i \frac{π}{4} {O}_{p}} , O = \frac{i}{2} [ {O}_{p} , {H}_{p} ] , {e}^{i γ {O}_{n}} = {e}^{i \frac{π}{4} {O}_{r}} {e}^{i γ {H}_{r}} {e}^{- i \frac{π}{4} {O}_{r}} , {O}_{n} = \frac{i}{2} [ {O}_{r} , {H}_{r} ] ,$$

with selected third primary operator Oₚ=σ_{z}⁰σ_{z}¹, third auxiliary operator Hₚ=σₓ¹σₓ², fourth primary operator Oₚ=σ_{z}⁰σ_{z}¹, and fourth auxiliary operator Hᵣ=σ_{z}³σₓ⁴.

The multi-qubit interaction H_{d} has then been decomposed into primary operators O and auxiliary operators H that are two-qubit interactions.

The obtained term may be compared with the initial desired many-body Hamiltonian term H_{d}. In this example, these are equivalent and no further SQGs are required. However, if this were not the case, then one layer may be applied before and after the applied interactions, to obtain the correct Pauli operators. Moreover, further SQGs can be applied to convert any non-native TQGs into native ones. Since gates of XX and ZZ are considered to be native also in this example, no SQGs are needed in this example.

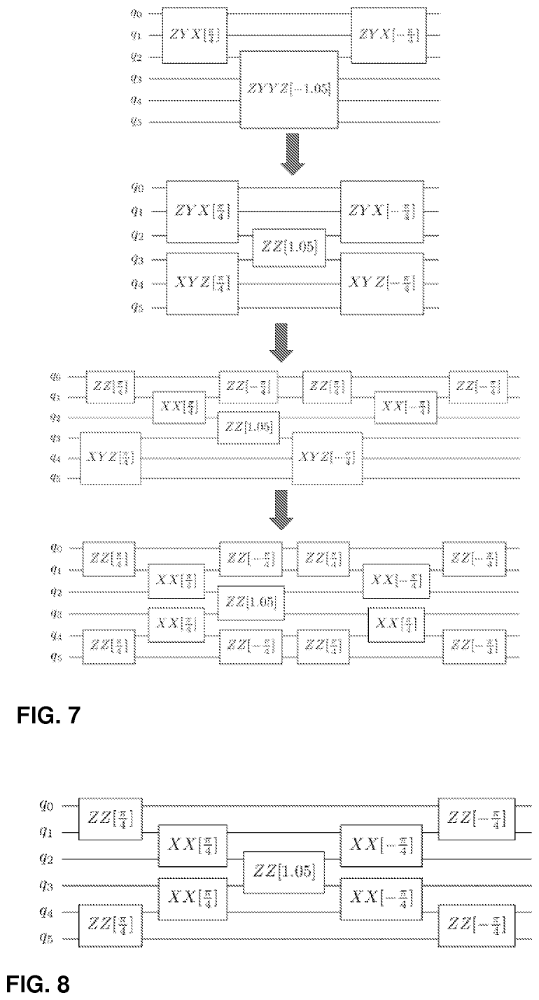

The above decomposition, i.e., the sequence of steps carried out algorithmically, is depicted in terms of quantum circuits in FIG. 7.

The quantum circuits of FIG. 7 follow the same notation and procedure as those of FIG. 5, with the exception that the third and fourth primary and auxiliary operators Oₚ, Hₚ, Oᵣ, Hᵣ are selected differently than in FIG. 5 as described above by the respective algorithms.

As illustrated in FIG. 8, the final quantum circuit of FIG. 7 is further optimized to reduce number of TQGs and circuit depth of the quantum circuit by cancelling any adjacent gates with opposite signs and acting on the same qubits. Commutation relations can be used when needed when reducing the number of TQGs and/or circuit depth. Since in the current example XX- and ZZ-type gates are considered to be native, no further SQGs are needed. However, if any of the gates were not native, further SQGs could be applied to convert the non-native gates into native ones.

In some embodiments, a qubit coupling path is utilized. A qubit coupling path may be determined based on the many-body Hamiltonian H_{d}. A qubit coupling is path may be obtained, e.g., as an input. In some embodiments, a qubit coupling path may be determined as part of the method.

A qubit coupling path could be directly obtained or determined also based on other input, such as an obtained H_{d} or information characterizing the many-body Hamiltonian H_{d}. For instance, in the case of the above example, where a many-body Hamiltonian H_{d} is given as σ_{z}⁰σ_{y}¹σ_{y}²σ_{y}³σ_{y}⁴σ_{z}⁵ and if it is known or information is obtained that indicates a linear connectivity of qubits, it may be determined that a qubit coupling path of connections [0,1], [1,2], [2,3], [3,4], and [4,5] may be utilized.

In some embodiments, a many-body Hamiltonian H_{d} could be obtained and a list of available connectivity between qubits may also be obtained. The method may then comprise providing a set of possible qubit coupling paths. A qubit coupling path comprising the minimum number of qubit connecting links could be selected to provide a shortest possible circuit depth.

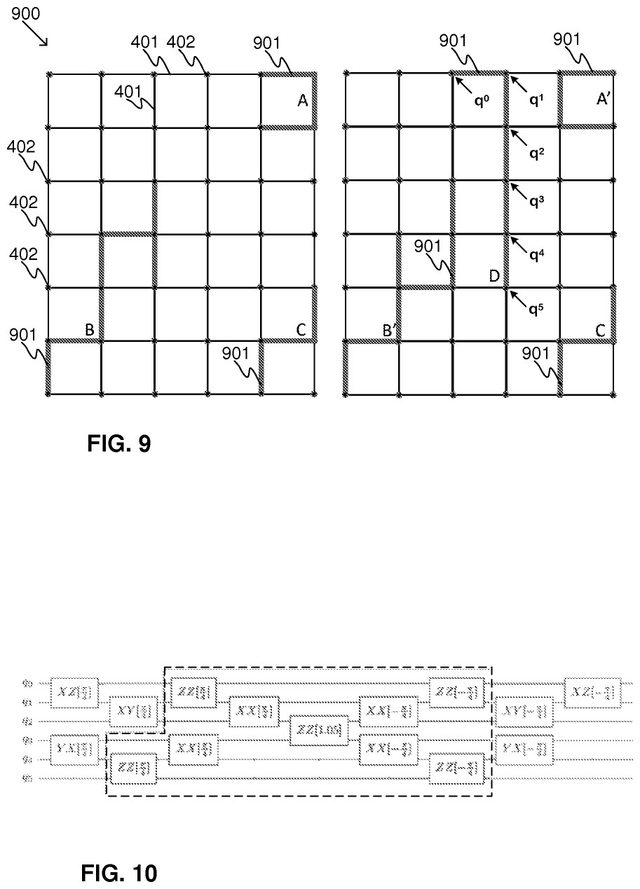

FIG. 9 illustrates some possible qubit coupling paths 901 on a quantum device employing a square lattice topology (linear connectivity 900). The dots represent qubits 402 of the device, thin lines represent qubit connecting links 401, while thicker lines represent qubit coupling paths 901. Qubit coupling paths A and A′ may be utilized to generate a four-body term, while B and B′ may be utilized to generate an eight-body term. A and A′ are alternatives providing similar circuit depth, as are B and B′. Thus, in both cases either qubit coupling path could be chosen. Regarding the four-body term of example C, there is not alternative path available. However, in many cases it may be that several different qubit coupling paths are available in connection with the desired many-body term, while the path giving the minimum circuit depth may advantageously be chosen in the method.

In some embodiments, a central qubit may be defined based on the obtained or determined qubit coupling path. For example, a central qubit may be defined as at least one of the identified qubits in the many-body Hamiltonian H_{d}, where the longest chain determined from a set of shortest chains linking the central qubit to any other qubit of the many-body Hamiltonian H_{d} along the determined or obtained qubit coupling path, the longest chain comprising the largest number of qubit connecting links, involves a smaller or equal number of qubits compared to the longest chain determined from a set of is shortest chains linking any non-central qubit to any other qubit of the many-body Hamiltonian H_{d} along the determined or obtained qubit coupling path.

Embodiments of the invention may be employed for determining a control sequence for simulating a quantum many-body Hamiltonian H_{d} comprising qubits that are not directly couplable (disconnected qubits) in the quantum device on which H_{d} is to be implemented.

As an example, a desired many-body Hamiltonian H_{d} to be implemented may be H_{d}=σ_{y}⁰σ_{z}⁴σ_{z}⁵ and a quantum device may be one where every qubit is connected to its nearest neighbor only, as shown in FIG. 9. According to FIG. 9, no direct connecting path involving only the qubits of the many-body Hamiltonian H_{d} is available. In such a case the method according to an embodiment of the invention may determine at least one qubit coupling path connecting the qubits of the many-body Hamiltonian H_{d} via additional qubits of the quantum device.

The method could involve determining a shortest path connecting the qubits of the many-body Hamiltonian H_{d} via additional qubits of the quantum device. In case multiple paths of the same length are available, one may be chosen by the user, based on a preconfigured selection principle by the first computing device, or randomly by the first computing device. If no qubit coupling path connecting qubits of the many-body Hamiltonian H_{d} via additional qubits of the quantum device can be found, an error message may be produced, for example.

In the example of H_{d}=σ_{y}⁰σ_{z}⁴σ_{z}⁵ considered above, a possible qubit coupling path found is illustrated by path D in FIG. 9. The qubit coupling path D comprises six qubits labeled 0 to 5, where every qubit is connected to its nearest neighbor only.

A replacement many-body Hamiltonian H_{d} may then be determined based on the determined path such that H_{d} comprises a tensor product of M′=6 Pauli matrices acting on the six qubits of the path. H_{d} could thus be σ_{z}⁰σ_{y}¹σ_{y}²σ_{y}³σ_{y}⁴σ_{z}⁵, but other types of Pauli matrices could be selected.

Decomposition as described earlier may then be performed on H_{d} resulting in a decomposed sequence of two-qubit interactions. This sequence would implement the replacement many-body Hamiltonian H_{d} and not the initial H_{d} and thus an additional step of determining a sequence of two qubit interactions for implementing the original many-body Hamiltonian H_{d} may be is required.

The control sequence for the many-body Hamiltonian H_{d} may thus be obtained by supplementing the sequence obtained by decomposing the replacement many-body Hamiltonian H_{d} with additional two qubit interactions. In a first step, additional two qubit interaction described by a unitary e^{iA} of operator A₁ may be selected such that replacement many-body Hamiltonian H_{d}′A and A₁ anticommute, the square of A₁ is an identity matrix, and the commutator of A₁ and the replacement many-body Hamiltonian H′_{d} is proportional to a new multiqubit interaction comprising a tensor product of a number N of Pauli matrices, where N<M′, wherein the selection of A₁ is further based on the property that a square of a Pauli matrix is equal to an identity matrix.

In the example discussed here, A₁=σ_{z}¹σ_{y}² and the new multiqubit interaction [A₁,H_{d}]=σ_{z}⁰σ_{z}¹σ_{y}³σ_{y}⁴σ_{z}⁵ with N=5 Pauli matrices and the fact that σ_{y}²σ_{y}²=I may be utilized to reduce the number of Pauli matrices in the new multiqubit interaction.

In a second step, the sequence of two-qubit interactions obtained by decomposing the replacement many-body Hamiltonian H′_{d} may be supplemented by a two-qubit interaction described by a unitary e^{iA1} before the replacement many-body Hamiltonian H′_{d} sequence and with interaction described by a unitary e^{-iA1} after the H′_{d} sequence.

In a third step, the replacement many-body Hamiltonian H′_{d} may be replaced by the new multiqubit interaction [A₁, H′_{d}] and the above first and second steps may be repeated until N=M, M being the number of qubits acted on by many-body Hamiltonian H_{d}.

In the current example, the third step may comprise selecting A₂=σ_{y}³σₓ⁴ and finding the commutator [A₂, H′_{d}]=σ_{z}⁰σ_{z}¹σ_{z}⁴σ_{z}⁵ with N=4 Pauli matrices, and since N=4 is greater than M=3, the first and second steps may be repeated again by selecting A₃=σ_{z}⁰σ_{z}¹ and finding the commutator [A₃, H′_{d}]=σ_{y}⁰σ_{z}⁴σ_{z}⁵ with N=3. Since N=M, the method could stop here. The method could further comprise verifying whether [A₃, H′_{d}] is equal to the many-body Hamiltonian H_{d} and if not, then applying single qubit transformations, also referred to as rotations and corresponding to single qubit gates, to obtain the desired many-body Hamiltonian H_{d}.

FIG. 10 shows an example quantum circuit illustrating the above-described method of determining a control sequence of two qubit interactions for simulating a many-body Hamiltonian H_{d} in the case where some of the qubits of H_{d} are not directly connected (disconnected qubits) and thus where the qubit coupling path involves more qubits than the known or determined many-body Hamiltonian H_{d}. The terms encircled by a dashed line correspond to a control sequence of two qubit interactions obtained by decomposing the interaction term corresponding to replacement many-body Hamiltonian H′_{d}. The gates on the left and the right of the decomposed replacement many-body Hamiltonian H′_{d} term correspond to interactions implementing the Hamiltonians A₁, A₂, A₃ and their negatives respectively.

In general, the control sequence and thus quantum circuit (sequence of quantum gates) that may be provided with the present invention may be implemented in connection with various types of quantum devices. Various methods for controlling interactions between qubits to implement the quantum gates are also available, as will be known to the skilled person. In connection with a specific quantum device and for the determined control sequence to be implementable, instructions for applying the specified gates, e.g., details on an order and/or duration of voltages to be applied may be provided.

Embodiments of the present invention may also relate to a method for determining at least one characteristic of a system. The system may be related to an M-body interaction problem, where the system comprises the at least M bodies and a characteristic of the system to be determined is characterized by the M-body interaction problem. The system may, for example, be a molecule and the M-body interaction problem may be solving the electronic Schrbdinger equation giving the electronic structure of the molecule, with the electronic structure being the characteristic that is determined.

A many-body Hamiltonian H_{d} may be determined based on the system and the M-body interaction problem to be solved. A control sequence may then be determined according to methods described herein. A user of a first computing device may initiate the determining of the control sequence, and the control sequence may be delivered to a second (quantum) computing is device for comprising at least M qubits for implementation.

In use of the second computing device, a measurement gate may be applied to determine the characteristic of the system. The characteristic of the system could be an eigenenergy of the system. The method could be repeated multiple times in order to measure a characteristic of the system multiple times. Multiple measurements could give different eigenenergies of the system. The ground energy of the system could be estimated by finding the minimum eigenenergy from those obtained in the multiple measurements. Further characteristics of the ground state of the system could be found by repeating the method further until the estimated ground state energy is found and then applying further gates to obtain further characteristics.

The invention has been explained above with reference to the aforementioned embodiments, and several advantages of the invention have been demonstrated. It is clear that the invention is not restricted only to these embodiments, but comprises all possible embodiments within the scope of inventive thought and the following patent claims.

The features recited in dependent claims are mutually freely combinable unless otherwise explicitly stated.

1. A computer-implemented method for determining a control sequence for performing a series of qubit interactions on a plurality of qubits on a quantum device to simulate a quantum many-body Hamiltonian H_{d}, involving M qubits expressable as a tensor product of M Pauli matrices, the method comprising
determining a sequence of two-qubit interactions based on decomposing a multiqubit interaction term into a sequence of three interaction terms, a first interaction term described by a unitary e^{iuO} of a primary operator O where u is a coupling strength coefficient of O between the qubits on which the primary operator O acts, a second interaction term described by a unitary e^{iγH} of an auxiliary operator H, and a third interaction term described by a unitary e^{-iuO} of the negative of the primary operator −O, wherein H and O are each a tensor product of at least two Pauli matrices, wherein the first, second and third interaction terms produced by the decomposition involve fewer qubits than the original multiqubit interaction term,
the method comprising iterative decomposition of interaction terms relating to primary operators and auxiliary operators until the multiqubit interaction term has been decomposed into a sequence of two-qubit interaction terms each relating to an operator comprising a tensor product of two Pauli matrices, wherein the multiqubit interaction term of the first decomposition step is described by a unitary e^{iγHd} of the many-body Hamiltonian H_{d}, where γ is a coupling strength coefficient of H_{d}, and the multiqubit interaction term in any subsequent decomposition step(s) relates to a primary operator O or an auxiliary operator H,
wherein said decomposing is based at least on a known or determined many-body Hamiltonian H_{d} which identifies the qubits to be involved and types of corresponding Pauli matrices.

2. The method of claim 1, wherein the method comprises providing the two-qubit interactions obtained through the method as the control sequence as a computer-readable output deliverable for implementing on a quantum device.

3. The method of claim 1, wherein the square of the primary operator O is equal to an identity matrix.

4. The method of claim 1, wherein the decomposing is additionally based on a known or determined qubit coupling path, said qubit coupling path being indicative of qubit connecting links indicating at least the qubits of the many-body Hamiltonian H_{d} that are to be coupled when executing the determined control sequence on the quantum device.

5. The method of claim 4, wherein the method comprises obtaining the qubit coupling path as an input or determining the qubit coupling path, wherein the determined qubit coupling path leads to a selected circuit depth when the control sequence is executed on the quantum device.

6. The method of claim 4, wherein the method comprises obtaining information on qubit connectivity of the quantum device, and the qubit coupling path is based on the qubit connectivity, such that the qubit connecting links are available in the qubit connectivity.

7. The method of claim 6, wherein when multiple qubit coupling paths are available, a qubit coupling path is selected such that the selected qubit coupling path contains the lowest number of qubit connecting links from a set of available qubit coupling paths.

8. The method of claim 4, wherein if the qubit coupling path involves more qubits than the known or determined many-body Hamiltonian H_{d}, the method comprises
determining a replacement H′_{d} for replacing the many-body Hamiltonian H_{d} in the decomposing with the replacement H′_{d} comprising M′>M qubits in the qubit coupling path,
the decomposing being carried out based on the replacement H′_{d}, and
determining a sequence of two qubit interactions for implementing the original many-body Hamiltonian H_{d} by supplementing the decomposed sequence of two-qubit interactions with additional at least two qubit interactions, comprising the steps of:
selecting an additional at least two qubit interaction term described by a unitary e^{iA} of operator A, such that H′_{d} and A anticommute, the square of A is equal to an identity matrix and the commutator of A and H′_{d} results in a new multiqubit interaction comprising a tensor product of a number N of Pauli matrices, where N<M′, wherein the selection of A is further based on the property that a square of a Pauli matrix is equal to an identity matrix,
supplementing the decomposed sequence of two-qubit interactions with the selected two qubit interaction term on one side of the sequence and with the negative of the selected two qubit interaction term on the other side,
replacing H′_{d} with the commutator of H′_{d} and A obtained in the above steps and repeating the above steps until N=M.

9. The method of claim 1, wherein the method comprises
Selecting at least one of the identified qubits as a central qubit,
selecting a first auxiliary operator H as a tensor product of M_{H} Pauli matrices, where each Pauli matrix in the tensor product acts on a different qubit, said qubits selected from those specified by the many-body Hamiltonian H_{d} and the selection including the at least one central qubit, and where M_{H} is less than the number of Pauli matrices of the multiqubit interaction being decomposed,
selecting a first primary operator O as a tensor product of M_{O} Pauli matrices, where M_{O} is less than the number of Pauli matrices of the multiqubit interaction being decomposed and where each Pauli matrix in the tensor product acts on a different qubit, said qubits and Pauli matrices of the first primary operator O selected such that at least one qubit is one of the least one central qubits and H_{d} is proportional to the commutator of the primary operator O and the auxiliary operator H,
selecting the coupling strength coefficient of the primary operator O as μ=π/4+α*π where a is an integer, for isolating a single M-body term,
wherein the primary operator O and auxiliary operator H are selected to anticommute
wherein the iterative decomposing comprises repeatedly selecting subsequent primary and auxiliary operators until final primary operators and final auxiliary operators that are tensor products of two Pauli matrices and thus correspond to two-qubit interactions are obtained.

10. The method of claim 1, wherein the method comprises obtaining information on qubit connectivity of the quantum device, and if connectivity is indicative of a linear connectivity of qubits, wherein one qubit is couplable with at most two other qubits, the decomposing of a previously determined primary operator O comprises reselecting the central qubit(s) before selecting subsequent primary and auxiliary operators, wherein the central qubit is selected from qubits of the operator O that is being decomposed.

11. The method of claim 1, wherein the method additionally comprises obtaining information indicative of native interactions of the quantum device, the method comprising applying single-qubit gates in connection with two-qubit interactions in the control sequence that do not correspond to native gates of the quantum device to obtain two-qubit interactions that correspond to native gates of the quantum device.

12. A computer program product comprising program code means adapted to execute the method items of claim 1 when run on a computer.

13. A quantum circuit comprising a sequence of qubit interactions determined according to the method of claim 1, executable on a quantum device comprising at least M qubits for simulating a quantum many-body Hamiltonian.

14. A quantum device comprising at least M qubits, wherein the quantum device is configured to implement the sequence of qubit interactions determined according to the method of claim 1.

15. A method for determining at least one characteristic of a system, the method comprising:
determining an M-body interaction problem related to a system comprising at least M bodies, wherein at least one characteristic of the system is characterized by said M-body interaction problem,
determining a control sequence according to claim 1,
implementing said determined control sequence on a quantum device comprising at least M qubits, and
applying a measurement gate to determine the characteristic of the system.

16. The method of claim 5, wherein the method comprises obtaining information on qubit connectivity of the quantum device, and the qubit coupling path is based on the qubit connectivity, such that the qubit connecting links are available in the qubit connectivity.

17. The method of claim 16, wherein when multiple qubit coupling paths are available, a qubit coupling path is selected such that the selected qubit coupling path contains the lowest number of qubit connecting links from a set of available qubit coupling paths.
